(19) United States
(12) Patent Application Publication
(10) Pub. No.: US 2026/0032428 A1
(43) Pub. Date: Jan. 29, 2026

(54) METHOD AND APPARATUS FOR TRANSMITTING AND RECEIVING CAPABILITY INFORMATION, AND READABLE STORAGE MEDIUM

(71) Applicant: Beijing Xiaomi Mobile Software Co., Ltd., Beijing (CN)

(72) Inventor: Shengxiang GUO, Beijing (CN)

(21) Appl. No.: 18/997,422

(22) PCT Filed: Aug. 2, 2022
(86) PCT No.: PCT/CN2022/109749

§ 371 Date: Jan. 21, 2025

(51) Int. Cl. H04W 8/22; H04L 27/26

(52) U.S. Cl. CPC H04W 8/22; H04L 27/26025; H04L 27/2605

(57) ABSTRACT

A method for receiving capability information is performed by a network device and includes: receiving capability information from a user equipment, wherein the capability information is configured to indicate a minimum guard band supported by the user equipment in at least one frequency range; and determining, based on the capability information, configuration information, wherein the configuration information is configured to indicate a maximum number of resource blocks configurable for the user equipment in a set channel bandwidth.

### CROSS REFERENCE TO RELATED APPLICATIONS

This application is a US National Phase of International Application No. PCT/CN2022/109749, filed on Aug. 2, 2022, the entire content of which is incorporated herein by reference.

### TECHNICAL FIELD

The present disclosure relates to the field of wireless communication technologies and in particular to methods and apparatuses for transmitting and receiving capability information and readable storage mediums.

### BACKGROUND

In the Long Term Evolution (LTE) system of the 3rd Generation Partnership Project (3GPP) and the 5G New Radio (NR) system, a maximum number of supportable resource blocks (RBs) is fixed for a set channel bandwidth. Furthermore, the bandwidth value of a part of the set channel bandwidth used as edge guard band is also fixed. The guard band of the channel bandwidth determines the RB number configurable on the channel bandwidth.

### SUMMARY

According a first aspect of the present disclosure, there is provided a method for receiving capability information, which is performed by a network device. The method includes:
receiving capability information from a user equipment, where the capability information is configured to indicate a minimum guard band supported by the user equipment in at least one frequency range; and
determining, based on the capability information, configuration information, where the configuration information is configured to indicate a maximum number of resource blocks configurable for the user equipment in a set channel bandwidth.

In the method of the present disclosure, the network device knows, based on the capability information reported by the user equipment, a capability of the user equipment to support the minimum guard band, and adaptively configures a maximum number of resource blocks based on the capability of the user equipment. Therefore, in the set channel bandwidth, the network device can configure a larger number of resource blocks for a high-capability user equipment while reducing the part occupied by the guard band, thereby effectively improving the spectrum utilization rate of the channel bandwidth.

In some embodiments, the method further includes:
transmitting the configuration information to the user equipment.

In some embodiments, the frequency range corresponds to a channel bandwidth;
the capability information is configured to indicate a first ratio corresponding to at least one channel bandwidth, and the first ratio is a percentage of a minimum guard band to a corresponding channel bandwidth.

In some embodiments, the frequency range corresponds to a channel bandwidth supporting different subcarrier spacings;
the capability information is configured to indicate first ratios corresponding to different subcarrier spacings supported in at least one channel bandwidth, and each of the first ratios is a percentage of a respective minimum guard band to a corresponding channel bandwidth.

In some embodiments, the frequency range corresponds to a channel bandwidth supporting different subcarrier spacings;
the capability information is configured to indicate first ratios corresponding to different subcarrier spacings supported in at least one channel bandwidth or at least one channel bandwidth range, and each of the first ratios is a percentage of a respective minimum guard band to a corresponding channel bandwidth.

In some embodiments, determining the configuration information based on the capability information includes:
determining, based on the capability information, the maximum number of resource blocks in the set channel bandwidth to determine the configuration information.

In some embodiments, determining the maximum number of resource blocks in the set channel bandwidth based on the capability information includes:
determining, based on the set channel bandwidth, a set subcarrier spacing in the set channel bandwidth and a first ratio corresponding to the set subcarrier spacing, the maximum number of resource blocks.

In some embodiments, the frequency range corresponds to a channel bandwidth supporting different subcarrier spacings;
the capability information is configured to indicate bandwidths of the minimum guard bands corresponding to different subcarrier spacings supported in at least one channel bandwidth.

In some embodiments, determining the configuration information based on the capability information includes:
based on the set channel bandwidth in which the user equipment is located, a set subcarrier spacing in the set channel bandwidth and a bandwidth of a minimum guard band corresponding to the set subcarrier spacing, determining the maximum number of resource blocks in the set channel bandwidth.

According to a second aspect of the present disclosure, there is provided a method for transmitting capability information, which is performed by a user equipment. The method includes:
transmitting capability information to a network device, where the capability information is configured to indicate a minimum guard band supported by the user equipment in at least one frequency range.

In the method of the present disclosure, the user equipment reports its capability to support the minimum guard band to the network device and hence the network device knows the capability of the user equipment, such that the network device can adaptively configures a maximum number of resource blocks based on the capability of the user equipment. Therefore, in the set channel bandwidth, the network device can configure a larger number of resource blocks for a high-capability user equipment while reducing the part occupied by the guard band, thereby effectively improving the spectrum utilization rate of the channel bandwidth.

In some embodiments, the method further includes:
receiving configuration information from the network device, where the configuration information is configured to indicate a maximum number of resource blocks configurable for the user equipment in a set channel bandwidth.

In some embodiments, the frequency range corresponds to a channel bandwidth;
the capability information is configured to indicate a first ratio corresponding to at least one channel bandwidth, and the first ratio is a percentage of the minimum guard band to the corresponding channel bandwidth.

In some embodiments, the frequency range corresponds to a channel bandwidth supporting different subcarrier spacings;
the capability information is configured to indicate first ratios corresponding to different subcarrier spacings supported in at least one channel bandwidth, and each of the first ratios is a percentage of a respective minimum guard band to a corresponding channel bandwidth.

In some embodiments, the frequency range corresponds to a channel bandwidth supporting different subcarrier spacings;
the capability information is configured to indicate first ratios corresponding to different subcarrier spacings supported in at least one channel bandwidth or at least one channel bandwidth range, and each of the first ratios is a percentage of a respective minimum guard band to a corresponding channel bandwidth.

In some embodiments, the frequency range corresponds to a channel bandwidth supporting different subcarrier spacings;
the capability information is configured to indicate bandwidths of minimum guard bands corresponding to different subcarrier spacings supported in at least one channel bandwidth.

According to a third aspect of the present disclosure, there is provided an apparatus for receiving capability information. The apparatus can be configured to perform the steps performed by the network device in the above first aspect. The network device can implement each function of the above method in the form of hardware structure, software module, or combination of hardware structure and software module.

When the apparatus shown in the third aspect is implemented by software module, the apparatus can include a transmitting and receiving module and a processing module, which can be coupled to each other. The transmitting and receiving module can be configured to support a communication device to perform communication and the processing module can be configured to support the communication device to perform processing operations, for example, generate to-be-sent information/message or process received signals to obtain information/message.

When the steps of the first aspect are performed, the transmitting and receiving module is configured to receive capability information from a user equipment, where the capability information is configured to indicate a minimum guard band supported by the user equipment in at least one frequency range.

The processing module is configured to determine configuration information based on the capability information, where the configuration information is configured to indicate a maximum number of resource blocks configurable for the user equipment in a set channel bandwidth.

According to a fourth aspect of the present disclosure, there is provided an apparatus for transmitting capability information. The apparatus can be configured to perform the steps performed by the user equipment in the above second aspect. The user equipment can implement each function of the above method in the form of hardware structure, software module, or combination of hardware structure and software module.

When the apparatus shown in the fourth aspect is implemented by software module, the apparatus includes a transmitting and receiving module, where the transmitting and receiving module is configured to support a communication device to perform communication.

When the steps in the above second aspect are performed, the transmitting and receiving module is configured to transmit capability information to a network device, where the capability information is configured to indicate a minimum guard band supported by the user equipment in at least one frequency range.

According to a fifth aspect of the present disclosure, there is provided a communication device, including a processor and a memory. The memory is configured to store computer programs and the processor is configured to execute the computer programs to carry out the first aspect.

According to a sixth aspect of the present disclosure, there is provided a communication device, including a processor and a memory. The memory is configured to store computer programs and the processor is configured to execute the computer programs to carry out the second aspect.

According to a seventh aspect of the present disclosure, there is provided a computer readable storage medium storing instructions (or computer programs or programs), where the instructions are invoked and executed on a computer to cause the computer to carry out the first aspect.

According to an eighth aspect of the present disclosure, there is provided a computer readable storage medium storing instructions (or computer programs or programs), where the instructions are invoked and executed on a computer to cause the computer to carry out the second aspect.

It should be understood that the above general descriptions and subsequent detailed descriptions are only illustrative and explanatory rather than limiting of the present disclosure.

### BRIEF DESCRIPTION OF THE DRAWINGS

The drawings described herein are configured to provide further understanding of the embodiments of the present disclosure and constitute a part of the present disclosure. The illustrative examples of the embodiments of the present disclosure and its descriptions are configured to interpret the embodiments of the present disclosure and do not constitute any improper limitation to the embodiments of the present disclosure.

The accompanying drawings, which are incorporated in and constitute a part of the present description, illustrate examples consistent with the embodiments of the present disclosure and serve to explain the principles of the embodiments of the present disclosure together with the description.

FIG. 1 is an architecture schematic diagram illustrating a wireless communication system according to an embodiment of the present disclosure.

FIG. 2 is a flowchart illustrating a method for transmitting capability information according to an embodiment of the present disclosure.

FIG. 3 is a flowchart illustrating another method for transmitting capability information according to an embodiment of the present disclosure.

FIG. 4 is a flowchart illustrating a method for receiving capability information according to an embodiment of the present disclosure.

FIG. 5 is a flowchart illustrating another method for receiving capability information according to an embodiment of the present disclosure.

FIG. 6 is a flowchart illustrating another method for receiving capability information according to an embodiment of the present disclosure.

FIG. 7 is a flowchart illustrating another method for receiving capability information according to an embodiment of the present disclosure.

FIG. 8 is a flowchart illustrating another method for receiving capability information according to an embodiment of the present disclosure.

FIG. 9 is a flowchart illustrating a method for transmitting capability information according to an embodiment of the present disclosure.

FIG. 10 is a flowchart illustrating another method for transmitting capability information according to an embodiment of the present disclosure.

FIG. 11 is a block diagram illustrating an apparatus for receiving capability information according to an embodiment of the present disclosure.

FIG. 12 is a block diagram illustrating a communication device according to an embodiment of the present disclosure.

FIG. 13 is a block diagram illustrating an apparatus for transmitting capability information according to an embodiment of the present disclosure.

FIG. 14 is a block diagram illustrating a user equipment according to an embodiment of the present disclosure.

### DETAILED DESCRIPTION OF THE EMBODIMENTS

The embodiments of the present disclosure will be further described below in combination with drawings and specific implementations.

Embodiments will be described in details herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the embodiments of the present disclosure are for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any or all possible combinations of one or more of the associated listed items.

It should be understood that, although the terms “first,” “second,” “third,” and the like may be used in the present disclosure to describe various information, such information should not be limited to these terms. These terms are only configured to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

The embodiments of the present disclosure will be described below in details with the examples thereof shown in the accompanying drawings, and the same or similar reference numerals represent same or similar elements throughout the specification. The embodiments described hereunder by referring to the drawings are illustrative and intended to interpret the present disclosure and shall not be understood as limiting of the present disclosure.

As shown in FIG. 1, an embodiment of the present disclosure provides a method for transmitting capability information, which can be applied to a wireless communication system 100. The wireless communication system can include a user equipment 101 and a network device 102. The user equipment 101 is configured to support carrier aggregation and can be connected to multiple carrier units of the network device 102, for example, to one primary carrier unit and one or more secondary carrier units.

It should be understood that the above wireless communication system 100 can be applied to not only low-frequency scenarios but also high-frequency scenarios. The application scenarios of the wireless communication system 100 include but not limited to long term evolution (LTE) system, LTE frequency division duplex (FDD) system, LTE time division duplex (TDD) system, worldwide interoperability for micro wave access (WiMAX) communication system, cloud radio access network (CRAN) system, future 5th-Generation (5G) system, new radio (NR) communication system or future evolved public land mobile network (PLMN) system and the like.

The above user equipment 101 may be a terminal, an access terminal, a terminal unit, a terminal station, a mobile station (MS), a remote station, a remote terminal, a mobile terminal, a wireless communication device, a terminal agency or a terminal device or the like. The user equipment 101 may have wireless transmitting and receiving function to communicate (e.g. wirelessly communicate) with one or more network devices in one or more communication systems and accept a network service provided by the network device. The network device herein includes but not limited to the network device 102 shown.

The UE 101 may be a cell phone, a cordless telephone, a session initiation protocol (SIP) telephone, a wireless local loop (WLL) station, a personal digital assistant (PDA) device, a palm-held device or computing device having wireless communication function, or another processing device connected to wireless modem, a vehicle-mounted device, a wearable device, a terminal device in future 5G network or a terminal device in a future evolved PLMN network or the like.

The network device 102 may be an access network device (or referred to as access network site). The access network device refers to a device providing network access function, such as a radio access network (RAN) base station and the like. The network device 102 may specifically include a base station (BS) or include a base station and a radio resource management device for controlling the base station and the like. The network device 102 may also include a relay station (relay device), an access point, a base station in future 5G network, a base station in future evolved PLMN network or an NR base station or the like. The network device 102 may be a wearable device or vehicle-mounted device. The network device 102 may also be a communication chip having a communication module.

For example, the network device 102 may include but not limited to a next-generation base station (gnodeB, gNB) in 5G, an evolved node B (eNB) in LTE system, a radio network controller (RNC), a node B (NB) in WCDMA system, a radio controller in CRAN system, a base station controller (BSC), a base transceiver station (BTS) in GSM system or CDMA system, a home base station (e.g. home evolved nodeB or home node B, HNB), a baseband unit (BBU), a transmitting and receiving point (TRP), a transmitting point (TP) or a mobile exchange center or the like.

With reference to Table 1, in the 5G NR, channel bandwidths (BW_{channel}) and a maximum number of resource blocks (NRB) configurable for its bandwidth for transmission are defined.

TABLE 1

| | 5 | 10 | 15 | 20 | 25 | 30 | 40 | 50 | 60 | 70 | 80 | 90 | 100 |
|---|---|---|---|---|---|---|---|---|---|---|---|---|---|
| SCS | MHz | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A | N/A |
| 30 | 11 | 24 | 38 | 51 | 65 | 78 | 106 | 133 | 162 | 189 | 217 | 245 | 273 |
| 60 | N/A | 11 | 18 | 24 | 31 | 38 | 51 | 65 | 79 | 93 | 107 | 121 | 135 |

With reference to Table 2, in the 5G NR, channel bandwidths and minimum guard bands corresponding to subcarrier spacings (SCS) are defined.

TABLE 2

| SCS | 5 | 10 | 15 | 20 | 25 | 30 | 35 | 40 | 45 | 50 | 60 | 70 | 80 | 90 | 100 |
|---|---|---|---|---|---|---|---|---|---|---|---|---|---|---|---|
| (kHz) | MHz | MHz | MHz | MHz | MHz | MHz | MHz | MHz | MHz | MHz | MHz | \|MHz | MHz | MHz | MHz |
| 15 | 242.5 | 312.5 | 382.5 | 452.5 | 522.5 | 592.5 | 572.5 | 552.5 | 712.5 | 692.5 | N/A | N/A | N/A | N/A | N/A |
| 30 | 505 | 665 | 645 | 805 | 785 | 945 | 925 | 905 | 1065 | 1045 | 825 | 965 | 925 | 885 | 845 |
| 60 | N/A | 1010 | 990 | 1330 | 1310 | 1290 | 1630 | 1610 | 1590 | 1570 | 1530 | 1490 | 1450 | 1410 | 1370 |

For a high-capability user equipment 101, its minimum guard band in a set channel bandwidth may be less than the minimum guard band indicated in the Table 2. The minimum guard band determines a maximum number of configurable resource blocks of the user equipment 101 on a channel bandwidth and corresponding SCSs. Therefore, the spectrum utilization rate of the channel bandwidth can be directly affected.

It is necessary to solve the problem of low spectrum utilization rate of a high-capability User Equipment (UE) due to large protocol-defined guard band.

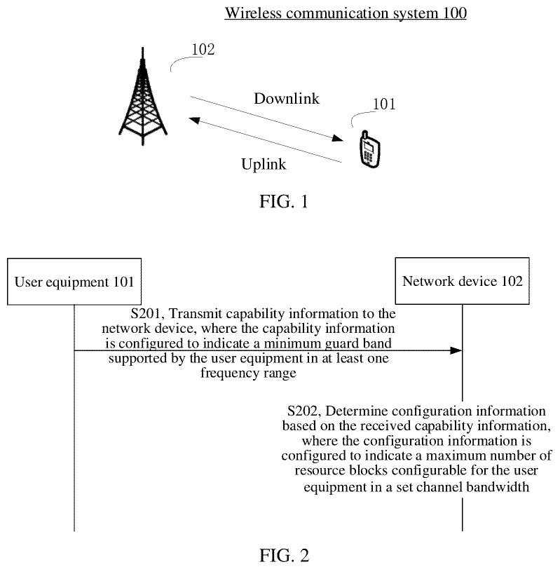

An embodiment of the present disclosure provides a method for transmitting capability information. With reference to FIG. 2, it shows a method for transmitting capability information according to an embodiment of the present disclosure. As shown in FIG. 2, the method includes steps S201 to S202.

At step S201, the user equipment 101 transmits capability information to the network device 102, where the capability information is configured to indicate a minimum guard band supported by the user equipment 101 in at least one frequency range.

At step S202, the network device 102 determines configuration information based on the received capability information, where the configuration information is configured to indicate a maximum number of resource blocks configurable for the user equipment 101 in a set channel bandwidth.

In some embodiments, the frequency range corresponds to a channel bandwidth.

In some embodiments, the frequency range corresponds to a channel bandwidth supporting different subcarrier spacings (SCSs).

In some embodiments, for the channel bandwidth (BW_{channel}) used by the user equipment 101, in order to protect in-band signal quality and suppress out-of-band radiation, it is required to configure a guard band or guard bandwidth at both ends of the channel bandwidth. The bandwidth part occupied by the guard band is not used for data transmission.

In some embodiments, the larger the bandwidth part occupied by the guard band is, the smaller the part of the corresponding channel bandwidth for data transmission is and the smaller the number of the configurable resource blocks (RBs) is.

In some embodiments, the capability information reported by the user equipment 101 indicates the minimum guard band supportable by the user equipment in the channel bandwidth.

In an example, in a same channel bandwidth, the minimum guard band indicated in the capability information reported by the user equipment 101 is less than the protocol-defined minimum guard band corresponding to the channel bandwidth.

The smaller the minimum guard band is, the larger the part of the channel bandwidth for data transmission is and the larger the maximum number of the configurable resource blocks is.

In some embodiments, the set channel bandwidth is configured to represent a frequency band on which the user equipment performs data transmission. The network device 102 determines a maximum number of resource blocks in the set channel bandwidth or determines a maximum number of resource blocks corresponding to the set channel bandwidth supporting different subcarrier spacings.

In an embodiment of the present disclosure, the network device 102 knows, based on the capability information reported by the user equipment 101, a capability of the user equipment 101 to support the minimum guard band, and based on the capability of the user equipment 101, adaptively configures a maximum number of resource blocks. Therefore, in the set channel bandwidth, the network device 102 can configure a larger number of resource blocks for the high-capability user equipment 101 while reducing the part occupied by the guard band, thereby effectively improving the spectrum utilization rate of the channel bandwidth.

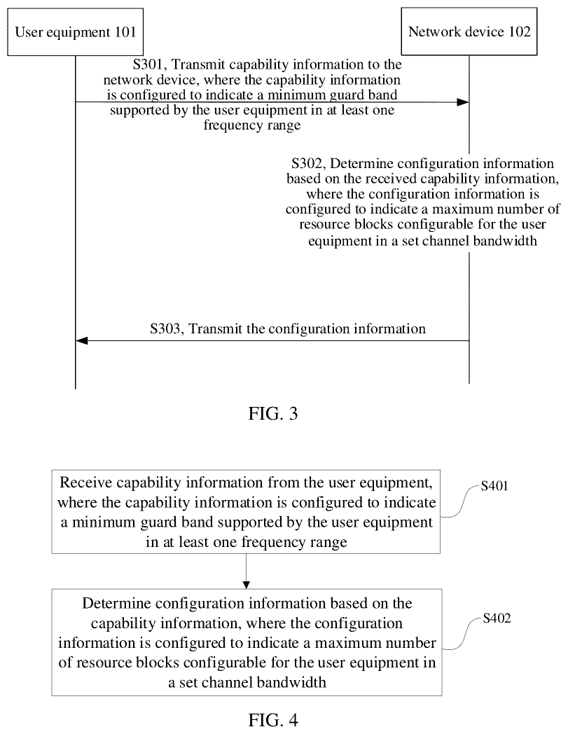

An embodiment of the present disclosure provides a method for transmitting capability information. With reference to FIG. 3, it shows a method for transmitting capability information according to an embodiment of the present disclosure. As shown in FIG. 3, the method includes steps S301 to S303.

At step S301, the user equipment 101 transmits capability information to the network device 102, where the capability information is configured to indicate a minimum guard band supported by the user equipment 101 in at least one frequency range.

At step S302, the network device 102 determines configuration information based on the received capability information, where the configuration information is configured to indicate a maximum number of resource blocks configurable for the user equipment 101 in a set channel bandwidth.

At step S303, the network device 102 transmits the configuration information to the user equipment 101.

In some embodiments, the capability information reported by the user equipment 101 indicates the minimum guard band supportable by the user equipment in the channel bandwidth.

In an example, in a same channel bandwidth, the minimum guard band indicated in the capability information reported by the user equipment 101 is less than the protocol-defined minimum guard band corresponding to the channel bandwidth.

In some embodiments, the network device 102 adaptively configures a maximum number of resource blocks based on the capability of the user equipment 101. The stronger the capability of the user equipment 101 to support the minimum guard band is, the larger the maximum number of resource blocks configurable by the network device 102 is, thereby effectively improving the spectrum utilization rate of the corresponding channel bandwidth.

In some embodiments, the set channel bandwidth is configured to represent a frequency band on which the user equipment 101 performs data transmission.

In an embodiment of the present disclosure, the network device 102 adaptively configures a maximum number of resource blocks based on the capability of the user equipment 101. Therefore, in the set channel bandwidth, the smaller the minimum guard band supported by the user equipment 101 is, the larger the number of resource blocks configurable by the network device 102 for the user equipment 101 is, thereby effectively improving the spectrum utilization rate of the channel bandwidth.

An embodiment of the present disclosure provides a method for receiving capability information, which is executed by the network device 102. With reference to FIG. 4, it shows a method for receiving capability information according to an embodiment of the present disclosure. As shown in FIG. 4, the method includes steps S401 to S402.

At step S401, the network device 102 receives capability information from the user equipment 101, where the capability information is configured to indicate a minimum guard band supported by the user equipment 101 in at least one frequency range.

At step S402, the network device 102 determines configuration information based on the capability information, where the configuration information is configured to indicate a maximum number of resource blocks configurable for the user equipment 101 in a set channel bandwidth.

In some embodiments, the frequency range corresponds to a channel bandwidth or a channel bandwidth supporting different subcarrier spacings (SCSs).

In an example, the capability information indicates a minimum guard band supported by the user equipment 101 in at least one channel bandwidth.

In an example, the capability information indicates a minimum guard band corresponding to the user equipment 101 supporting different subcarrier spacings in at least one channel bandwidth.

In some embodiments, for the channel bandwidth (BW_{channel}) used by the user equipment 101, in order to protect in-band signal quality and suppress out-of-band radiation, it is required to configure a guard band at both ends of the channel bandwidth. The bandwidth part occupied by the guard band is not used for data transmission.

In some embodiments, the capability information reported by the user equipment 101 indicates the minimum guard band supportable by the user equipment in the channel bandwidth.

In some embodiments, the set channel bandwidth is configured to represent a frequency band on which the user equipment 101 performs data transmission.

In some embodiments, the user equipment 101 can report the minimum guard bands supportable by multiple channel bandwidths respectively.

In some embodiments, the user equipment 101 can report the minimum guard bands supportable by multiple channel bandwidth ranges respectively.

In an embodiment of the present disclosure, the network device 102 knows the capability of the user equipment 101 to support the minimum guard band based on the capability information reported by the user equipment 101, and adaptively configures a maximum number of resource blocks based on the capability of the user equipment 101. Therefore, in the set channel bandwidth, the network device 102 can configure a larger number of resource blocks for the high-capability user equipment 101 while reducing the part occupied by the guard band, thereby effectively improving the spectrum utilization rate of the channel bandwidth.

An embodiment of the present disclosure provides a method for receiving capability information, which is executed by the network device 102. The method includes steps S401 to S403.

At step S401, the network device 102 receives capability information from the user equipment 101, where the capability information is configured to indicate a minimum guard band supported by the user equipment 101 in at least one frequency range.

At step S402, the network device 102 determines configuration information based on the capability information, where the configuration information is configured to indicate a maximum number of resource blocks configurable for the user equipment 101 in a set channel bandwidth.

At step S403, the network device 102 transmits the configuration information to the user equipment 101.

In some embodiments, the network device 102 can transmit to the user equipment 101 a Radio Resource Control (RRC) signaling carrying the configuration information.

In some embodiments, the network device 102 carries the configuration information by Downlink Control Information (DCI).

In some embodiments, the frequency range corresponds to a channel bandwidth and the user equipment 101 can report the minimum guard bands supportable by multiple channel bandwidths respectively.

The network device 102 determines the minimum guard band supportable by the set channel bandwidth based on the set channel bandwidth on which the user equipment 101 performs data transmission. In combination with the determined minimum guard band, the network device 102 performs RB configuration.

In some embodiments, the user equipment 101 can report the minimum guard bands supportable by multiple channel bandwidth ranges respectively.

The network device 102 determines a bandwidth range of the set channel bandwidth based on the set channel bandwidth on which the user equipment 101 performs data transmission, and determines the minimum guard band supportable by the bandwidth range. In combination with the determined minimum guard band, the network device 102 performs RB configuration.

In an embodiment of the present disclosure, the network device 102 can distribute the configuration information matching the capability of the user equipment 101 to the user equipment 101 so that the high-capability user equipment 101 can perform data transmission on larger bandwidth part, thereby improving the spectrum utilization rate.

An embodiment of the present disclosure provides a method for receiving capability information, which is executed by the network device 102. The method includes steps S401 to S402 or steps S401 to S403.

The frequency range corresponds to a channel bandwidth;
the capability information is configured to indicate a first ratio corresponding to at least one channel bandwidth, and the first ratio is a percentage of the minimum guard band to the corresponding channel bandwidth.

In some embodiments, the capability information includes the first ratios corresponding to multiple channel bandwidths respectively.

In an example:

The capability information indicates the first ratio corresponding to the user equipment 101 in the first channel bandwidth BW₁ is X₁%, the first ratio corresponding to the user equipment 101 in the second channel bandwidth BW₂ is X₂%, and the first ratio corresponding to the user equipment 101 in the third channel bandwidth BW₃ is X₃%.

In this example, X₁% represents a percentage of the minimum guard band supported by the user equipment 101 in the first channel bandwidth BW₁ to the first channel bandwidth BW₁. Therefore, the minimum guard band in the first channel bandwidth BW₁ is X₁%*BW₁.

X₂% represents a percentage of the minimum guard band supported by the user equipment 101 in the second channel bandwidth BW₂ to the second channel bandwidth BW₂. Therefore, the minimum guard band in the second channel bandwidth BW₂ is X₂%*BW₂.

X₃% represents a percentage of the minimum guard band supported by the user equipment 101 in the third channel bandwidth BW₃ to the second channel bandwidth BW₃. Therefore, the minimum guard band in the third channel bandwidth BW₃ is X₃%*BW₃.

In an example:

The capability information indicates that the first ratio corresponding to the user equipment 101 in the set channel bandwidth BW₀ is 5%. In this example, a ratio of the minimum guard band supported by the user equipment 101 in the set channel bandwidth BW₀ to the set channel bandwidth is 5%, i.e. 5%*BW0.

In some embodiments, in a scenario where the capability information indicates the first ratio corresponding to the channel bandwidth, the first ratio is applicable to a scenario where the corresponding channel bandwidth supports different subcarrier spacings (SCSs), that is, the channel bandwidth corresponds to the first ratio when supporting different subcarriers (SCSs).

In an example:

The first ratio corresponding to the user equipment 101 in the first channel bandwidth is X₁%, the first ratio corresponding to the user equipment 101 in the second channel bandwidth is X₂%, and the first ratio corresponding to the user equipment 101 in the third channel bandwidth is X₃%.

In this example, the X₁% is applicable to a scenario where the first channel bandwidth supports different SCSs, the X₂% is applicable to a scenario where the second channel bandwidth supports different SCSs, and the X₃% is applicable to a scenario where the third channel bandwidth supports different SCSs.

In an embodiment of the present disclosure, the user equipment 101 reports the minimum guard bands in the corresponding channel bandwidths by reporting the first ratio corresponding to each channel bandwidth.

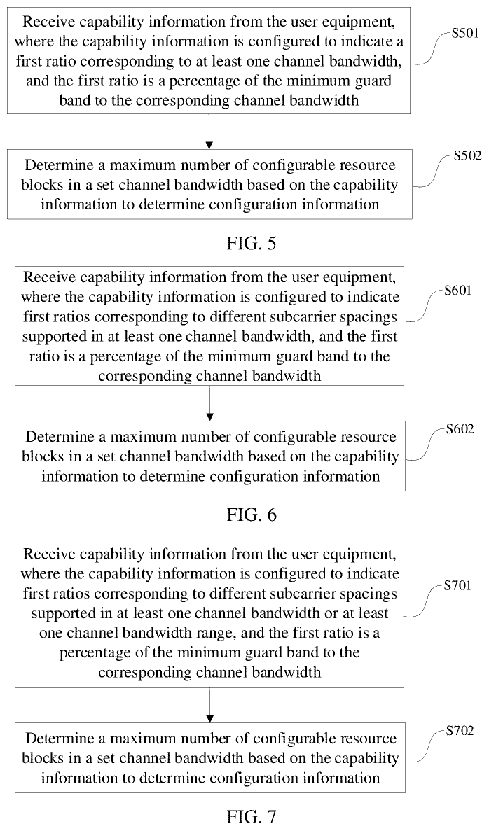

An embodiment of the present disclosure provides a method for receiving capability information, which is executed by the network device 102. With reference to FIG. 5, it shows a method for receiving capability information according to an embodiment of the present disclosure. As shown in FIG. 5, the method includes steps S501 to S502.

At step S501, the network device 102 receives capability information from the user equipment 101. The capability information is configured to indicate a first ratio corresponding to at least one channel bandwidth, and the first ratio is a percentage of the minimum guard band to the corresponding channel bandwidth.

At step S502, the network device 102 determines a maximum number of resource blocks in a set channel bandwidth based on the capability information to determine configuration information. The configuration information is configured to indicate a maximum number of resource blocks configurable for the user equipment 101 in the set channel bandwidth.

In some embodiments, the capability information includes the first ratios corresponding to multiple channel bandwidths respectively.

In an example, the capability information indicates the first ratio corresponding to the user equipment 101 in the first channel bandwidth BW₁ is X₁%, the first ratio corresponding to the user equipment 101 in the second channel bandwidth BW₂ is X₂%, and the first ratio corresponding to the user equipment 101 in the third channel bandwidth BW₃ is X₃%.

In some embodiments, in a scenario where the capability information indicates the first ratio corresponding to the channel bandwidth, the first ratio is applicable to a scenario where the channel bandwidth supports different subcarrier spacings (SCSs), that is, the channel bandwidth corresponds to the same first ratio when supporting different subcarriers (SCSs).

In some embodiments, the network device 102 can determine, based on the capability information of the user equipment 101, the first ratio X₀% corresponding to the set channel bandwidth BW₀ on which the user equipment 101 performs data transmission, and determine the minimum guard band corresponding to the set channel bandwidth BW₀ based on the first ratio X₀%. In this way, a maximum number of resource blocks corresponding to the set channel bandwidth can be determined.

In some embodiments, the step S502 may be the following step S502′.

At step S502′, the network device 102 determines a maximum number of resource blocks based on the set channel bandwidth, set subcarrier spacing in the set channel bandwidth and the corresponding first ratio.

In an example, the first ratios corresponding to the set channel bandwidth supporting different SCSs are same. Therefore, in the operation process, a maximum number of resource blocks for the user equipment 101 to support SCSs in the set bandwidth can be determined by the first ratio.

In some embodiments, the maximum number of resource blocks satisfies:

$$Floor ( ( 1 - 2 X \% ) * {BW}_{channel} / ( k * SCS ) ) ;$$

where X % represents the first ratio corresponding to the channel bandwidth, BW_{Channel} represents the channel bandwidth, SCS represents the SCS supported by the user equipment in the channel bandwidth, Floor ( ) represents rounding down a calculation result, k represents a number of SCSs in one resource block, for example, one resource block includes 12 SCSs and k=12.

The network device 102 can determine a maximum number of resource blocks in any channel bandwidth based on the formula.

In an embodiment of the present disclosure, in a scenario where the user equipment 101 reports the first ratio corresponding to the channel bandwidth, the network device 102 can determine a maximum number of resource blocks corresponding to the channel bandwidth supported by the user equipment 101, so as to configure reasonable configuration information for the user equipment 101.

An embodiment of the present disclosure provides a method for receiving capability information, which is executed by the network device 102. The method includes steps S401 to S402 or steps S401 to S403.

The frequency range corresponds to a channel bandwidth supporting different subcarrier spacings.

The capability information is configured to indicate first ratios corresponding to different subcarrier spacings supported in at least one channel bandwidth, and the first ratio is a percentage of the minimum guard band to the corresponding channel bandwidth.

In some embodiments, the capability information includes the first ratios corresponding to different SCSs supported under each channel bandwidth in multiple channel bandwidths.

In an example:

The capability information indicates that under the first channel bandwidth BW₁, the first ratio corresponding to the user equipment 101 supporting a first SCS is X₁₁%, the first ratio corresponding to the user equipment 101 supporting a second SCS is X₁₂%, and the first ratio corresponding to the user equipment 101 supporting a third SCS is X₁₃%; under the second channel bandwidth BW₂, the first ratio corresponding to the user equipment 101 supporting the first SCS is X₂₁%, the first ratio corresponding to the user equipment 101 supporting the second SCS is X₂₂%, and the first ratio corresponding to the user equipment 101 supporting the third SCS is X₂₃%.

In an example:

The capability information indicates that the corresponding first ratio is X₀₁% when the SCS supported by the user equipment 101 under the set channel bandwidth BW₀ is 15 kHz, and the corresponding first ratio is X₀₂% when the SCS is 60 kHz.

In an embodiment of the present disclosure, the user equipment 101 can report the corresponding first ratios respectively based on the supported channel bandwidth and different supported subcarriers.

An embodiment of the present disclosure provides a method for receiving capability information, which is executed by the network device 102. With reference to FIG. 6, it shows a method for receiving capability information according to an embodiment of the present disclosure. As shown in FIG. 6, the method includes steps S601 to S602.

At step S601, the network device 102 receives capability information from the user equipment 101. The capability information is configured to indicate first ratios corresponding to different subcarrier spacings supported in at least one channel bandwidth, and the first ratio is a percentage of the minimum guard band to the corresponding channel bandwidth.

At step S602, the network device 102 determines a maximum number of resource blocks in a set channel bandwidth based on the capability information to determine configuration information. The configuration information is configured to indicate a maximum number of resource blocks configurable for the user equipment 101 in the set channel bandwidth.

In some embodiments, the capability information includes the first ratios respectively corresponding to different SCSs under the channel bandwidth supported by the user equipment 101.

In an example:

The capability information indicates that under the first channel bandwidth BW₁, the first ratio corresponding to the user equipment 101 supporting the first SCS is X₁₁%, the first ratio corresponding to the user equipment 101 supporting the second SCS is X₁₂%, and the first ratio corresponding to the user equipment 101 supporting the third SCS is X₁₃%; under the second channel bandwidth BW₂, the first ratio corresponding to the user equipment 101 supporting the first SCS is X₂₁%, the first ratio corresponding to the user equipment 101 supporting the second SCS is X₂₂%, and the first ratio corresponding to the user equipment 101 supporting the third SCS is X₂₃%.

In an example:

The capability information indicates that the corresponding first ratio is X₀₁% when the SCS supported by the user equipment 101 under the set channel bandwidth BW₀ is 15 kHz, and the corresponding first ratio is X₀₂% when the SCS is 60 kHz.

In some embodiments, the steps S602 may be the following step S602′.

At step S602′, the network device 102 determines a maximum number of resource blocks based on the set channel bandwidth, set subcarrier spacing in the set channel bandwidth and the corresponding first ratio.

In an example, in combination with the capability information reported by the user equipment 101, the network device can determine the first ratio corresponding to each SCS supported by the set channel bandwidth on which the user equipment 101 performs data transmission, so as to determine maximum numbers of resource blocks corresponding to different SCSs supported under the set channel bandwidth.

In some embodiments, the maximum number of resource blocks satisfies:

$$Floor ( ( 1 - 2 X \% ) * {BW}_{channel} / ( k * SCS ) ) ;$$

where X % represents a first ratio corresponding to the channel bandwidth supporting different SCSs, BW_{Channel} represents the channel bandwidth, SCS represents the SCS supported by the user equipment in the channel bandwidth, Floor ( ) represents rounding down a calculation result, k represents a number of SCSs in one resource block, for example, one resource block includes 12 SCSs and k=12.

The network device 102 can determine a maximum number of resource blocks in any channel bandwidth based on the formula.

In an example:

When the SCS supported by the user equipment 101 under the set channel bandwidth BW₀ is 15 kHz, the corresponding first ratio is X₀₁% and when the SCS is 60 kHz, the corresponding first ratio is X₀₂%.

In the example, the network device 102 can respectively determine that:
the corresponding maximum number of resource blocks at a time of the SCS being 15 kHz is Floor ((1-2X₀₁%)*BW₀/(12*15)),
the corresponding maximum number of resource blocks at a time of the SCS being 60 kHz is Floor ((1−2X₀₂%)*BW₀/(12*60)).

In an embodiment of the present disclosure, in a scenario where the user equipment 101 reports the first ratios corresponding to different SCSs under the channel bandwidth, the network device 102 can correspondingly determine the maximum numbers of resource blocks corresponding to different SCSs supported under the channel bandwidth supported by the user equipment 101, so as to configure reasonable configuration information for the user equipment 101.

An embodiment of the present disclosure provides a method for receiving capability information, which is executed by the network device 102. The method includes steps S401 to S402 or steps S401 to S403.

The frequency range corresponds to a channel bandwidth supporting different subcarrier spacings;
the capability information is configured to indicate first ratios corresponding to different subcarrier spacings supported in at least one channel bandwidth or at least one channel bandwidth range, and the first ratio is a percentage of the minimum guard band to the corresponding channel bandwidth.

In some embodiments, the capability information reported by the user equipment 101 indicates the first ratios corresponding to different SCSs supported by the user equipment 101 under different channel bandwidth ranges.

In some embodiments, the channel bandwidth range can be divided into multiple levels.

In an example, a first channel bandwidth range corresponds to a channel bandwidth less than 20 MHz.

In an example, a second channel bandwidth range corresponds to a channel bandwidth of [20 MHz, 40 MHz].

In an example, a third channel bandwidth range corresponds to a channel bandwidth of [40 MHz, 100 MHz].

In some embodiments, the capability information indicates the first ratios corresponding to different SCSs supported under the channel bandwidth range.

In an example, the capability information indicates that under the first channel bandwidth range, the first ratio corresponding to the user equipment 101 supporting the first SCS is X₁₁%, the first ratio corresponding to the user equipment 101 supporting the second SCS is X₁₂% and the first ratio corresponding to the user equipment 101 supporting the third SCS is X₁₃%.

In an example, the capability information indicates that under the second channel bandwidth range, the first ratio corresponding to the user equipment 101 supporting the first SCS is X₂₁%, the first ratio corresponding to the user equipment 101 supporting the second SCS is X₂₂% and the first ratio corresponding to the user equipment 101 supporting the third SCS is X₂₃%.

In an embodiment of the present disclosure, the user equipment 101 can report the corresponding first ratios respectively based on the supported channel bandwidth range and different subcarriers supported under the corresponding channel bandwidth range.

An embodiment of the present disclosure provides a method for receiving capability information, which is executed by the network device 102. With reference to FIG. 7, it shows a method for receiving capability information according to an embodiment of the present disclosure. As shown in FIG. 7, the method includes steps S701 to S702.

At step S701, the network device 102 receives capability information from the user equipment 101. The capability information is configured to indicate first ratios corresponding to different subcarrier spacings supported in at least one channel bandwidth or at least one channel bandwidth range, and the first ratio is a percentage of the minimum guard band to the corresponding channel bandwidth.

At step S702, the network device 102 determines a maximum number of resource blocks in a set channel bandwidth based on the capability information to determine configuration information. The configuration information is configured to indicate a maximum number of resource blocks configurable for the user equipment in the set channel bandwidth.

In some embodiments, the capability information includes the first ratios corresponding to different SCSs under each channel bandwidth range in multiple channel bandwidth ranges supported by the user equipment 101.

In an example, the capability information indicates that under the first channel bandwidth range, the first ratio corresponding to the user equipment 101 supporting the first SCS is X₁₁%, the first ratio corresponding to the user equipment 101 supporting the second SCS is X₁₂% and the first ratio corresponding to the user equipment 101 supporting the third SCS is X₁₃%.

In an example, the capability information indicates that under the second channel bandwidth range, the first ratio corresponding to the user equipment 101 supporting the first SCS is X₂₁%, the first ratio corresponding to the user equipment 101 supporting the second SCS is X₂₂% and the first ratio corresponding to the user equipment 101 supporting the third SCS is X₂₃%.

In some embodiments, the network device 102 determines a channel bandwidth range of the set channel bandwidth on which the user equipment 101 performs data transmission, and then determines first ratios corresponding to different SCSs supported under the channel bandwidth range and further determines minimum guard bands corresponding to different SCSs supported under the channel bandwidth range.

In some embodiments, the step S702 may be the following steps S702′.

At step S702′, the network device 102 determines a maximum number of resource blocks based on the set channel bandwidth, the set subcarrier spacing in the set channel bandwidth and the corresponding first ratio.

In an example, based on the capability information and the set channel bandwidth on which the user equipment 101 performs data transmission, the network device 102 determines that the set channel bandwidth is in the first channel bandwidth range.

In some embodiments, the maximum number of resource blocks satisfies:

$$Floor ( ( 1 - 2 X \% ) * {BW}_{channel} / ( k * SCS ) ) ;$$

where X % represents the first ratios corresponding to different SCSs supported in the channel bandwidth range, BW_{Channel} represents the channel bandwidth, SCS represents the SCS supported by the user equipment in the channel bandwidth, Floor ( ) represents rounding down a calculation result. The network device 102 can determine a maximum number of resource blocks in any channel bandwidth based on the formula. k represents a number of SCSs in one resource block, for example, one resource block includes 12 SCSs and k=12.

In an example:

The capability information indicates that under the first channel bandwidth range, the first ratio corresponding to the user equipment 101 supporting the first SCS (SCS₁) is X₁₁%, the first ratio corresponding to the user equipment 101 supporting the second SCS (SCS₂) is X₁₂% and the first ratio corresponding to the user equipment 101 supporting the third SCS (SCS₃) is X₁₃%; under the second channel bandwidth range, the first ratio corresponding to the user equipment 101 supporting the first SCS is X₂₁%, the first ratio corresponding to the user equipment 101 supporting the second SCS is X₂₂% and the first ratio corresponding to the user equipment 101 supporting the third SCS is X₂₃%.

The set channel bandwidth is in the first channel bandwidth range.

In the example, the network device 102 can respectively determine, under the set channel bandwidth, namely, under the first channel bandwidth range,
a corresponding maximum number of resource blocks at a time of supporting SCS1 is Floor ((1−2X₁₁%)*BW_{Channel}/(12*SCS₁));
a corresponding maximum number of resource blocks at a time of supporting SCS2 is Floor ((1−2X₁₂%)*BW_{Channel}/(12*SCS₂));
a corresponding maximum number of resource blocks at a time of supporting SCS3 is Floor ((1−2X₁₃%)*BW_{Channel}/(12*SCS₃)).

In an embodiment of the present disclosure, in a scenario where the user equipment 101 reports the first ratios corresponding to different SCSs under the channel bandwidth range, the network device 102 can correspondingly determine the channel bandwidth range of the channel bandwidth supported by the user equipment 101, and then in combination with the first ratios corresponding to different SCSs under the channel bandwidth range, determine a maximum number of resource blocks corresponding to the set channel bandwidth, so as to configure reasonable configuration information for the user equipment 101.

An embodiment of the present disclosure provides a method for receiving capability information, which is executed by the network device 102. The method includes steps S401 to S402, or steps S401 to S403.

The frequency range corresponds to a channel bandwidth supporting different subcarrier spacings;
the capability information is configured to indicate bandwidths of the minimum guard bands corresponding to different subcarrier spacings supported in at least one channel bandwidth.

In some embodiments, the capability information indicates a bandwidth value of the minimum guard bands corresponding to different SCSs supported in multiple channel bandwidths supported by the user equipment 101.

In an example:

The capability information indicates that under the first channel bandwidth BW₁, the minimum guard band corresponding to the user equipment 101 supporting the first SCS is Y₁₁, the minimum guard band corresponding to the user equipment 101 supporting the second SCS is Y₁₂, and the minimum guard band corresponding to the user equipment 101 supporting the third SCS is Y₁₃; under the second channel bandwidth BW₂, the minimum guard band corresponding to the user equipment 101 supporting the first SCS is Y₂₁, the minimum guard band corresponding to the user equipment 101 supporting the second SCS is Y₂₂, and the minimum guard band corresponding to the user equipment 101 supporting the first SCS is Y₂₃.

In an example:

The capability information indicates that, when the SCS supported by the user equipment 101 under the set channel bandwidth BW₀ is 15 kHz, the bandwidth value of the corresponding minimum guard band is Y₀₁ MHz, and when the SCS is 60 kHz, the bandwidth value of the corresponding minimum guard band is Y₀₂ MHz.

In an embodiment of the present disclosure, the user equipment 101 reports the bandwidth values of the minimum guard bands corresponding to different SCSs supported under the corresponding channel bandwidth.

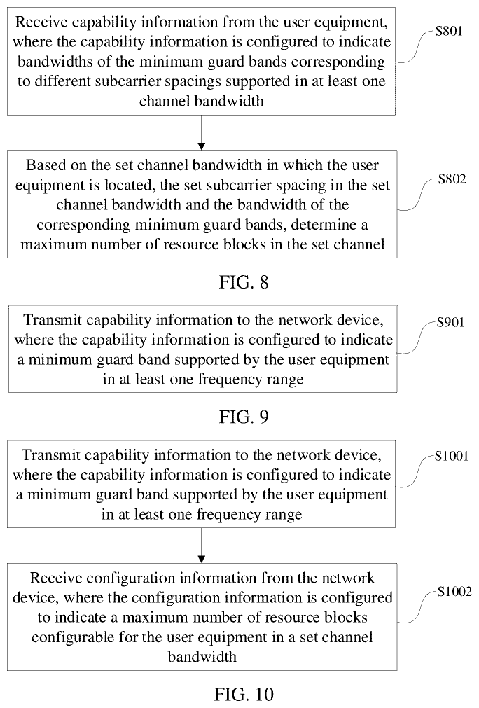

An embodiment of the present disclosure provides a method for receiving capability information, which is executed by the network device 102. With reference to FIG. 8, it shows a method for receiving capability information according to an embodiment of the present disclosure. As shown in FIG. 8, the method includes steps S801 to S802.

At step S801, the network device 102 receives capability information from the user equipment 101. The capability information is configured to indicate bandwidths of the minimum guard bands corresponding to different subcarrier spacings supported in at least one channel bandwidth.

At step S802, based on the set channel bandwidth in which the user equipment 101 is located, the set subcarrier spacing in the set channel bandwidth and the bandwidth of the corresponding minimum guard bands, the network device 102 determines a maximum number of resource blocks in the set channel bandwidth.

In some embodiments, the network device 102 determines a bandwidth value of the minimum guard bands corresponding to different SCSs under the set channel bandwidth based on the capability information so as to determine a corresponding maximum number of resource blocks.

In some embodiments, the maximum number of resource blocks satisfies:

$$Floor ( ( ( {BW}_{channel} - 2 Y / ( k * SCS ) ) ;$$

where Y represents the bandwidths of the minimum guard bands corresponding to different SCSs supported in the channel bandwidth, BW_{Channel} represents the channel bandwidth, SCS represents the SCS supported by the user equipment in the channel bandwidth, and Floor ( ) represents rounding down a calculation result. The network device 102 can determine a maximum number of resource blocks in any channel bandwidth based on the formula. k represents a number of SCSs in one resource block, for example, one resource block includes 12 SCSs, and k=12.

In an example:

The capability information indicates that under the first channel bandwidth BW₁, the minimum guard band corresponding to the user equipment 101 supporting the first SCS is Y₁₁, the minimum guard band corresponding to the user equipment 101 supporting the second SCS is Y₁₂, and the minimum guard band corresponding to the user equipment 101 supporting the third SCS is Y₁₃; under the second channel bandwidth BW₂, the minimum guard band corresponding to the user equipment 101 supporting the first SCS is Y₂₁, the minimum guard band corresponding to the user equipment 101 supporting the second SCS is Y₂₂, and the minimum guard band corresponding to the user equipment 101 supporting the third SCS is Y₂₃. When the SCS supported by the user equipment 101 under the set channel bandwidth BW₀ is 15 kHz, the bandwidth value of the corresponding minimum guard band is Y₀₁ MHz, and when the SCS is 60 kHz, the bandwidth value of the corresponding minimum guard band is Y₀₂ MHz.

The network device 102 determines the maximum numbers of resource blocks of different SCSs under the set channel bandwidth based on the information under the set channel bandwidth BW₀.

In the example, the network device 102 can respectively determine that:
a corresponding maximum number of resource blocks at a time of the SCS being 15 kHz under the set channel bandwidth BW₀ is:

$$Floor ( {BW}_{0} - 2 {Y}_{01} ) / ( 12 * 15 ) ;$$

a corresponding maximum number of resource blocks at a time of the SCS being 60 kHz under the set channel bandwidth BW₀ is:

$$Floor ( {BW}_{0} - 2 {Y}_{02} ) / ( 12 * 60 ) .$$

In an embodiment of the present disclosure, in a scenario where the user equipment 101 reports the bandwidths of the minimum guard bands corresponding to different SCSs under the channel bandwidth, the network device 102 can determine the maximum numbers of resource blocks corresponding to different SCSs supported by the user equipment 101 under the set channel bandwidth, so as to configure reasonable configuration information for the user equipment 101.

An embodiment of the present disclosure provides a method for transmitting capability information, which is executed by the user equipment 101. With reference to FIG. 9, it shows a method for transmitting capability information according an embodiment of the present disclosure. As shown in FIG. 9, the method includes step S901.

At step S901, the user equipment 101 transmits capability information to the network device 102. The capability information is configured to indicate a minimum guard band supported by the user equipment 101 in at least one frequency range.

In some embodiments, the frequency range corresponds to a channel bandwidth or a channel bandwidth supporting different subcarrier spacings (SCSs).

In an example, the capability information indicates a minimum guard band supported by the user equipment 101 in at least one channel bandwidth.

In an example, the capability information indicates minimum guard bands corresponding to different subcarriers spacings supported by the user equipment 101 in at least one channel bandwidth.

In the embodiments of the present disclosure, the user equipment 101 reports its capability to support the minimum guard band to the network device 102 and hence the network device 102 knows the capability of the user equipment 101, such that the network device 102 can adaptively configures a maximum number of resource blocks based on the capability of the user equipment 101. Therefore, in the set channel bandwidth, the network device 102 can configure a larger number of resource blocks for a high-capability user equipment 101 while reducing the part occupied by the guard band, thereby effectively improving the spectrum utilization rate of the channel bandwidth.

An embodiment of the present disclosure provides a method for transmitting capability information, which is executed by the user equipment 101. With reference to FIG. 10, it shows a method for transmitting capability information according to an embodiment of the present disclosure. As shown in FIG. 10, the method includes steps S1001 to S1002.

At step S1001, the user equipment 101 transmits capability information to the network device 102. The capability information is configured to indicate a minimum guard band supported by the user equipment 101 in at least one frequency range.

At step S1002, the user equipment 101 receives configuration information from the network device 102. The configuration information is configured to indicate a maximum number of resource blocks configurable for the user equipment in a set channel bandwidth.

In some embodiments, the frequency range corresponds to a channel bandwidth or a channel bandwidth supporting different subcarrier spacings (SCSs).

In an example, the capability information indicates a minimum guard band supported by the user equipment 101 in at least one channel bandwidth.

In an example, the capability information indicates minimum guard bands corresponding to different subcarrier spacings supported by the user equipment 101 in at least one channel bandwidth.

In an embodiment of the present disclosure, the user equipment 101 can receive configuration information matching its capability from the network device 102 such that the high-capability user device 101 can perform data transmission on larger bandwidth part, thereby improving the spectrum utilization rate.

An embodiment of the present disclosure provides a method for transmitting capability information, which is executed by the user equipment 101. The method includes steps S901 or steps S1001 to S1002.

The frequency range corresponds to a channel bandwidth.

The capability information is configured to indicate a first ratio corresponding to at least one channel bandwidth, and the first ratio is a percentage of the minimum guard band to the corresponding channel bandwidth.

In an embodiment of the present disclosure, by reporting the first ratio corresponding to each channel bandwidth, the user equipment 101 reports the minimum guard band in the corresponding channel bandwidth.

An embodiment of the present disclosure provides a method for transmitting capability information, which is executed by the user equipment 101. The method includes step S901 or steps S1001 to S1002.

The frequency range corresponds to a channel bandwidth supporting different subcarrier spacings.

The capability information is configured to indicate first ratios corresponding to different subcarrier spacings supported in at least one channel bandwidth, and the first ratio is a percentage of the minimum guard band to the corresponding channel bandwidth.

In an embodiment of the present disclosure, the user equipment 101 can report the corresponding first ratios respectively based on the supported channel bandwidth and supported different subcarriers.

An embodiment of the present disclosure provides a method for transmitting capability information, which is executed by the user equipment 101. The method includes step S901 or steps S1001 to S1002.

The frequency range corresponds to a channel bandwidth supporting different subcarrier spacings.

The capability information is configured to indicate first ratios corresponding to different subcarrier spacings supported in at least one channel bandwidth or at least one channel bandwidth range, and the first ratio is a percentage of the minimum guard band to the corresponding channel bandwidth.

In an embodiment of the present disclosure, the user equipment 101 can report the corresponding first ratios respectively based on the supported channel bandwidth range and different subcarriers supported in the corresponding channel bandwidth range.

An embodiment of the present disclosure provides a method for transmitting capability information, which is executed by the user equipment 101. The method includes step S901 or steps S1001 to S1002.

The frequency range corresponds to a channel bandwidth supporting different subcarrier spacings.

The capability information is configured to indicate bandwidths of the minimum guard bands corresponding to different subcarrier spacings supported in at least one channel bandwidth.

In an embodiment of the present disclosure, the user equipment 101 reports a bandwidth value of the minimum guard bands corresponding to different SCSs supported under the corresponding channel bandwidth.

Based on the same idea as the above method embodiments, an embodiment of the present disclosure provides an apparatus for receiving capability information. The apparatus can have the functions of the network device 102 in the above method embodiments, and can be configured to perform the steps performed by the network device 102 in the above method embodiments. The functions can be implemented by hardware or by software or by implementing corresponding software through hardware. The hardware or software includes one or more modules corresponding to the above functions.

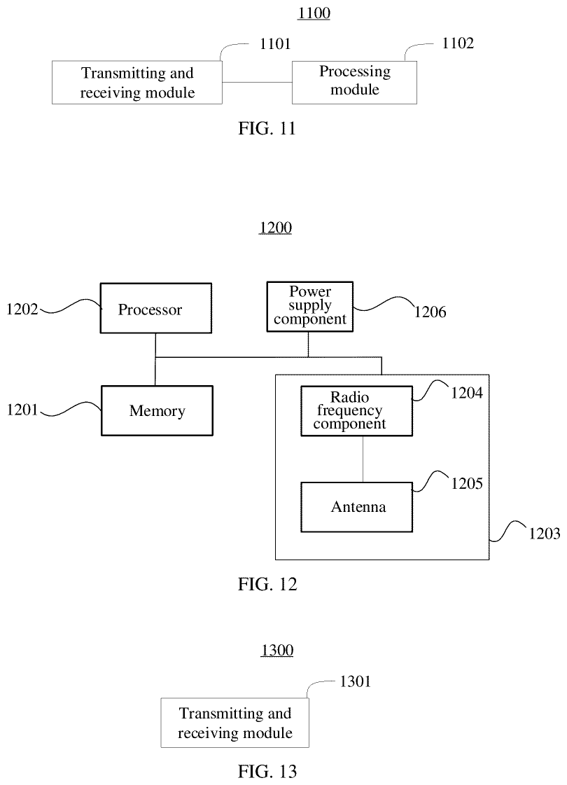

In an embodiment, the communication device 1100 shown in FIG. 11 can be used as the network device 102 in the above method embodiments and perform the steps performed by the network device 102 in the above method embodiments. As shown in FIG. 11, the communication device 1100 may include a transmitting and receiving module 1101 and a processing module 1102 which are coupled to each other. The transmitting and receiving module 1101 can be configured to support the communication device to perform communication and the transmitting and receiving module 1101 can have wireless communication function, for example, to perform wireless communication with other communication device via wireless air interface. The processing module 1102 can be configured to support the communication device to perform processing operations, for example, generate to-be-sent information/message or process received signals to obtain information/message.

When the steps performed by the network device 102 are performed, the transmitting and receiving module 1101 is configured to receive capability information from the user equipment 101. The capability information is configured to indicate a minimum guard band supported by the user equipment 101 in at least one frequency range.

The processing module 1102 is configured to determine configuration information based on the capability information. The configuration information is configured to indicate a maximum number of resource blocks configurable for the user equipment 101 in a set channel bandwidth.

In some embodiments, the transmitting and receiving module 1101 is further configured to transmit configuration information to the user equipment.

In some embodiments, the frequency range corresponds to a channel bandwidth and the capability information is configured to indicate a first ratio corresponding to at least one channel bandwidth, and the first ratio is a percentage of the minimum guard band to the corresponding channel bandwidth.

In some embodiments, the frequency range corresponds to a channel bandwidth supporting different subcarrier spacings; the capability information is configured to indicate first ratios corresponding to different subcarrier spacings supported in at least one channel bandwidth, and the first ratio is a percentage of the minimum guard band to the corresponding channel bandwidth.

In some embodiments, the frequency range corresponds to a channel bandwidth supporting different subcarrier spacings; the capability information is configured to indicate first ratios corresponding to different subcarrier spacings supported in at least one channel bandwidth or at least one channel bandwidth range, and the first ratio is a percentage of the minimum guard band to the corresponding channel bandwidth.

In some embodiments, the processing module 1102 is further configured to determine a maximum number of resource blocks in a set channel bandwidth based on the capability information to determine the configuration information.

In some embodiments, the processing module 1102 is further configured to determine a maximum number of resource blocks based on the set channel bandwidth, set subcarrier spacing in the set channel bandwidth and the corresponding first ratio.

In some embodiments, the frequency range corresponds to a channel bandwidth supporting different subcarrier spacings; the capability information is configured to indicate bandwidths of the minimum guard bands corresponding to different subcarrier spacings supported in at least one channel bandwidth.

In some embodiments, the processing module 1102 is further configured to determine a maximum number of resource blocks in the set channel bandwidth based on the set channel bandwidth where the user equipment is located, the set subcarrier spacing in the set channel bandwidth and the bandwidth of the corresponding minimum guard band.

When the communication device is the network device 102, its structure can also be as shown in FIG. 12. The structure of the communication device is described with base station as example. As shown in FIG. 12, the apparatus 1200 includes a memory 1201, a processor 1202, a transmitting and receiving component 1203, and a power supply component 1206. The memory 1201 is coupled with the processor 1202 and can be configured to store programs and data necessary for the communication device 1200 to perform various functions. The processor 1202 is configured to support the communication device 1200 to perform the corresponding functions in the above method. The functions can be implemented by invoking programs in the memory 1201. The transmitting and receiving component 1203 may be a wireless transceiver which can be configured to support the communication device 1200 to receive signaling and/or data and transmit signaling and/or data via wireless air interface. The transmitting and receiving component 1203 can also be referred to as transmitting and receiving unit or communication unit. The transmitting and receiving component 1203 may include a radio frequency component 1204 and one or more antennas 1205. The radio frequency component 1204 may be a remote radio unit (RRU), which specifically may be used for transmission of radio signals and conversion between radio signal and baseband signal. The one or more antennas 1205 are specifically used for radiation and reception of radio signals.

When the communication device 1200 needs to transmit data, the processor 1202 can perform baseband processing on the to-be-sent data and then output baseband signals to the radio unit, and the radio unit can perform radio processing on the baseband signals and then transmit the radio signals in the form of electromagnetic wave via the antennas. When there is data to be transmitted to the communication device 1200, the radio unit can receive radio signals via the antennas and convert the radio signals into baseband signals and output the baseband signals to the processor 1202, and the processor 1202 can convert the baseband signals into data and process the data.

Based on the same idea as the above method embodiments, an embodiment of the present disclosure further provides an apparatus for receiving capability information. The apparatus can have the functions of the user device 101 in the above method embodiments, and can be configured to perform the steps performed by the user device 101 in the above method embodiments. The functions can be implemented by hardware or by software or by implementing corresponding software through hardware. The hardware or software includes one or more modules corresponding to the above functions.

In an embodiment, the apparatus 1300 as shown in FIG. 13 can be used as the user equipment 101 in the above method embodiments and perform the steps performed by the user equipment 101 in the above method embodiments. As shown in FIG. 13, the apparatus 1300 may include a transmitting and receiving module 1301 which is configured to support the communication device to perform communication.

When the steps performed by the user equipment 101 are performed, the transmitting and receiving module 1301 is configured to transmit capability information to the network device 102. The capability information is configured to indicate a minimum guard band supported by the user equipment in at least one frequency range.

In some embodiments, the transmitting and receiving module 1301 is further configured to receive configuration information from the network device. The configuration information is configured to indicate a maximum number of resource blocks configurable for the user equipment in a set channel bandwidth.

In some embodiments, the frequency range corresponds to a channel bandwidth; the capability information is configured to indicate a first ratio corresponding to at least one channel bandwidth, and the first ratio is a percentage of the minimum guard band to the corresponding channel bandwidth.

In some embodiments, the frequency range corresponds to a channel bandwidth supporting different subcarrier spacings; the capability information is configured to indicate first ratios corresponding to different subcarrier spacings supported in at least one channel bandwidth, and the first ratio is a percentage of the minimum guard band to the corresponding channel bandwidth.

In some embodiments, the frequency range corresponds to a channel bandwidth supporting different subcarrier spacings; the capability information is configured to indicate first ratios corresponding to different subcarrier spacings supported in at least one channel bandwidth or at least one channel bandwidth range, and the first ratio is a percentage of the minimum guard band to the corresponding channel bandwidth.

In some embodiments, the frequency range corresponds to a channel bandwidth supporting different subcarrier spacings; the capability information is configured to indicate bandwidths of the minimum guard bands corresponding to different subcarrier spacings supported in at least one channel bandwidth.

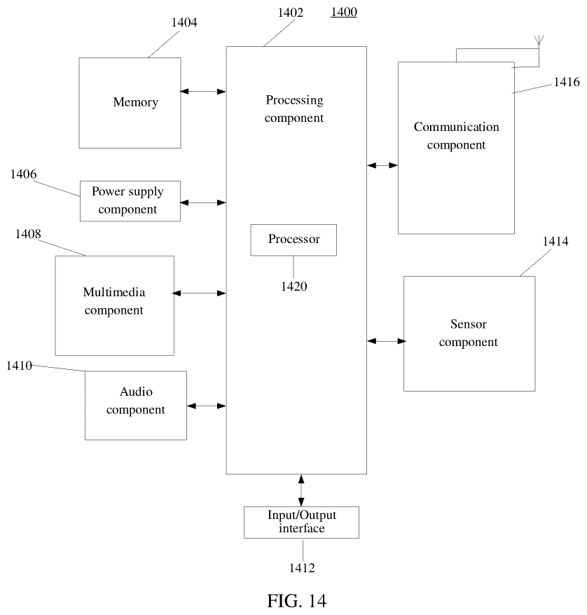

When the apparatus receiving the configuration information is the user equipment 101, its structure can also be as shown in FIG. 14. The apparatus 1400 may be a mobile phone, a computer, a digital broadcast terminal, a message transceiver, a game console, a tablet device, a medical device, a fitness device, a personal digital assistant, and the like.

As shown in FIG. 14, the apparatus 1400 may include one or more of the following components: a processing component 1402, a memory 1404, a power supply component 1406, a multimedia component 1408, an audio component 1410, an input/output (I/O) interface 1412, a sensor component 1414 and a communication component 1416.

The processing component 1402 generally controls overall operations of the apparatus 1400, such as operations associated with display, phone calls, data communications, camera operations, and recording operations. The processing component 1402 may include one or more processors 1420 to execute instructions to complete all or part of the steps of the above methods. In addition, the processing component 1402 may include one or more modules which facilitate the interaction between the processing component 1402 and other components. For example, the processing component 1402 may include a multimedia module to facilitate the interaction between the multimedia component 1408 and the processing component 1402.

The memory 1404 is configured to store various types of data to support the operation of the apparatus 1400. Examples of such data include instructions for any application or method operated on the apparatus 1400, contact data, phonebook data, messages, pictures, videos, and so on. The memory 1404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 1406 supplies power for different components of the apparatus 1400. The power supply component 1406 may include a power supply management system, one or more power supplies, and other components associated with generating, managing and distributing power for the apparatus 1400.

The multimedia component 1408 includes a screen that provides an output interface between the apparatus 1400 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 1408 includes a front camera and/or a rear camera. When the apparatus 1400 is in an operation mode, such as a shooting mode or a video mode, the front camera and/or the rear camera may receive external multimedia data. Each of the front and rear cameras may be a fixed optical lens system or have a focal length and an optical zoom capability.

The audio component 1410 is configured to output and/or input audio signals. For example, the audio component 1410 includes a microphone (MIC) configured to receive an external audio signal when the apparatus 1400 is in an operation mode, such as a call mode, a recording mode, and a voice recognition mode. The received audio signal may be further stored in the memory 1404 or transmitted via the communication component 1416. In some examples, the audio component 1410 also includes a loudspeaker for outputting an audio signal.

The I/O interface 1412 provides an interface between the processing component 1402 and a peripheral interface module which may be a keyboard, a click wheel, a button, or the like. These buttons may include, but are not limited to a home button, a volume button, a start button, and a lock button.

The sensor component 1414 includes one or more sensors for providing a status assessment in various aspects to the apparatus 1400. For example, the sensor component 1414 may detect an open/closed state of the apparatus 1400, and the relative positioning of components, for example, the component is a display and a keypad of the apparatus 1400. The sensor component 1414 may also detect a change in position of the apparatus 1400 or a component of the apparatus 1400, the presence or absence of a user in contact with the apparatus 1400, the orientation or acceleration/deceleration of the apparatus 1400 and a change in temperature of the apparatus 1400. The sensor component 1414 may include a proximity sensor configured to detect the presence of nearby objects without any physical contact. The sensor component 1414 may also include a light sensor, such as a CMOS or CCD image sensor, for use in imaging applications. In some examples, the sensor component 1414 may also include an acceleration sensor, a gyro sensor, a magnetic sensor, a pressure sensor, or a temperature sensor.

The communication component 1416 is configured to facilitate wired or wireless communication between the apparatus 1400 and other devices. The apparatus 1400 may access a wireless network based on a communication standard, such as WIFI, 2G or 3G, or a combination thereof. In an example, the communication component 1416 receives broadcast signals or broadcast associated information from an external broadcast management system via a broadcast channel. In an example, the communication component 1416 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the apparatus 1400 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements for performing the above methods.

In an embodiment, there is provided a non-transitory computer readable storage medium including instructions, for example, a memory 1404 including instructions. The above instructions may be executed by a processor 1420 of the apparatus 1400 to perform the above methods. For example, the non-transitory computer readable storage medium may be ROM, RAM, or CD-ROM, magnetic tape, floppy disk or optical state storage device or the like.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure indicated by the following claims.

It should be understood that the present disclosure is not limited to the precise structure described above and shown in the accompanying drawings, and that various modifications and changes may be made without departing from the scope thereof. The scope of the present disclosure is limited only by the appended claims.

### INDUSTRIAL APPLICABILITY

In the methods of the present disclosure, the network device knows the capability of the user equipment to support the minimum guard band based on the capability information reported by the user equipment, and adaptively configures a maximum number of resource blocks based on the capability of the user equipment. Thus, in a set channel bandwidth, the network device can configure a larger number of resource blocks for the high-capability user equipment while reducing the part occupied by the guard band, thereby effectively improving the spectrum utilization rate of the channel bandwidth.

1. A method for receiving capability information, performed by a network device and comprising:
receiving capability information from a user equipment, wherein the capability information is configured to indicate a minimum guard band supported by the user equipment in at least one frequency range; and
determining, based on the capability information, configuration information, wherein the configuration information is configured to indicate a maximum number of resource blocks configurable for the user equipment in a set channel bandwidth.

2. The method of claim 1, further comprising:
transmitting the configuration information to the user equipment.

3. The method of claim 1, wherein,
the frequency range corresponds to a channel bandwidth; and
the capability information is configured to indicate a first ratio corresponding to at least one channel bandwidth, and the first ratio is a percentage of a minimum guard band to a corresponding channel bandwidth.

4. The method of claim 1, wherein,
the frequency range corresponds to a channel bandwidth supporting different subcarrier spacings; and
the capability information is configured to indicate first ratios corresponding to different subcarrier spacings supported in at least one channel bandwidth, and each of the first ratios is a percentage of a respective minimum guard band to a corresponding channel bandwidth.

5. The method of claim 1, wherein,
the frequency range corresponds to a channel bandwidth supporting different subcarrier spacings; and
the capability information is configured to indicate first ratios corresponding to different subcarrier spacings supported in at least one channel bandwidth or at least one channel bandwidth range, and each of the first ratios is a percentage of a respective minimum guard band to a corresponding channel bandwidth.

6. The method of claim 3, wherein determining, based on the capability information, the configuration information comprises:
determining, based on the capability information, the maximum number of resource blocks in the set channel bandwidth to determine the configuration information.

7. The method of claim 6, wherein determining the maximum number of resource blocks in the set channel bandwidth based on the capability information comprises:
determining, based on the set channel bandwidth, a set subcarrier spacing in the set channel bandwidth and a first ratio corresponding to the set subcarrier spacing, the maximum number of resource blocks.

8. The method of claim 1, wherein,
the frequency range corresponds to a channel bandwidth supporting different subcarrier spacings; and
the capability information is configured to indicate bandwidths of minimum guard bands corresponding to different subcarrier spacings supported in at least one channel bandwidth.

9. The method of claim 8, wherein determining, based on the capability information, the configuration information comprises:
based on the set channel bandwidth in which the user equipment is located, a set subcarrier spacing in the set channel bandwidth and a bandwidth of a minimum guard band corresponding to the set subcarrier spacing, determining the maximum number of resource blocks in the set channel bandwidth.

10. A method for transmitting capability information, performed by a user equipment and comprising:
transmitting capability information to a network device, wherein the capability information is configured to indicate a minimum guard band supported by the user equipment in at least one frequency range.

11. The method of claim 10, further comprising:
receiving configuration information from the network device, wherein the configuration information is configured to indicate a maximum number of resource blocks configurable for the user equipment in a set channel bandwidth.

12. The method of claim 10, wherein,
the frequency range corresponds to a channel bandwidth; and
the capability information is configured to indicate a first ratio corresponding to at least one channel bandwidth, and the first ratio is a percentage of a minimum guard band to a corresponding channel bandwidth.

13. The method of claim 10, wherein,
the frequency range corresponds to a channel bandwidth supporting different subcarrier spacings; and
the capability information is configured to indicate first ratios corresponding to different subcarrier spacings supported in at least one channel bandwidth, and each of the first ratios is a percentage of a respective minimum guard band to a corresponding channel bandwidth.

14. The method of claim 10, wherein,
the frequency range corresponds to a channel bandwidth supporting different subcarrier spacings; and
the capability information is configured to indicate first ratios corresponding to different subcarrier spacings supported in at least one channel bandwidth or at least one channel bandwidth range, and each of the first ratios is a percentage of a respective minimum guard band to a corresponding channel bandwidth.

15. The method of claim 10, wherein,
the frequency range corresponds to a channel bandwidth supporting different subcarrier spacings; and
the capability information is configured to indicate bandwidths of minimum guard bands corresponding to different subcarrier spacings supported in at least one channel bandwidth.

16. (canceled)

17. (canceled)

18. A communication device, comprising:
a processor; and
a memory storing computer programs executable by the processor;
wherein the processor is configured to:
receive capability information from a user equipment, wherein the capability information is configured to indicate a minimum guard band supported by the user equipment in at least one frequency range; and
determine, based on the capability information, configuration information, wherein the configuration information is configured to indicate a maximum number of resource blocks configurable for the user equipment in a set channel bandwidth.

19. A communication device, comprising:
a processor; and
a memory storing computer programs executable by the processor;
the processor is configured to perform the method of claim 10.

20. A non-transitory computer readable storage medium, storing instructions thereon, wherein the instructions, when executed by a processor, cause the processor to perform the method of claim 1.

21. A non-transitory computer readable storage medium, storing instructions thereon, wherein the instructions, when executed by a processor, cause the processor to perform the method of claim 10.
